(19) United States
(12) Patent Application Publication
(10) Pub. No.: US 2003/0018596 A1
(43) Pub. Date: Jan. 23, 2003

(54) Deductive object-oriented data mining system

(76) Inventor: Hou-Mei Henry Chang, Stafford, TX (US)

Correspondence Address: HOU-MEI HENRY CHANG, PHD, 14020 SCHROEDER, #120, HOUSTON, TX, 77070, US

(21) Appl. No.: 09/883,626

(22) Filed: Jun. 18, 2001

(51) Int. Cl. G06F 15/18; G06N 7/02; G06N 7/06; G06F 9/44

(52) U.S. Cl. 706/12

(57) ABSTRACT

Deductive Object-Oriented Data Mining System (Doodms) is a predictive data mining system. Its goal is generating prediction rules from given databases or any given data sets. In Doodms, the difficult data mining problem is reduced to a series of probability problems, each of which is not only much easier to be solved but also has much better mathematical basis. The generate-count-and-test methodology, which contains generate, count, and test processes, is applied in Doodms. Since it is object-oriented, each instance is treated as an object. Since it is deductive, the generate-process is from more general cases to less general cases. Since an important theorem is proved and applied, the data mining process is greatly sped up. Since no heuristics are applied, the generated results are mathematical rigorous and the tolerance for each case can be set by the user.

### BACKGROUND OF THE INVENTION

This invention relates to the field of data mining, which in academic terminology is called machine learning. Data mining is a technology that can find hidden knowledge from databases or any data sets. More precisely, this invention is in the area of predictive data mining, which generates prediction rules from any given database or data set. In other words, these prediction rules predict future events based on a large amount of existing data about events happened before.

Almost every company has its own database, but only a small part of knowledge in the database is accessed. Data mining system can help the user discover much more knowledge from his/her databases.

Currently, the user treats each instance of a database as an independent item. But data mining system treats all instances in a database as a whole. Its goal is using the digital computer to find out some patterns from all instances in the database.

The difficult problem in data mining is its time complexity problem. Because the number of combinations of all values in all attributes of a medium-sized database is an astronomical number, it has been proved that to complete a data mining problem of a medium-sized database by a classical method may take thousands of years by modem computers.

In order to speed up the data mining process, different heuristics are introduced by different authors. Heuristics are some assumptions, which look like reasonable or have been proved as acceptable approximations in some special cases. However, such heuristics are correct or acceptable only in some special cases but not in other cases and the general case.

These heuristics are not the same as approximations used in mathematics and engineering areas. Once they are applied, no tolerances can be calculated beforehand or afterward, and nobody knows what prediction rules are missing and how important the missing prediction rules are.

Therefore, a new data mining system is required. And it must satisfy the following requirements:

The process is fast enough to mine any regular-sized database and generate acceptable prediction rules from the database by current computer hardware technology.

The algorithm must be mathematically rigorous and accurate.

If any approximation method is applied, the tolerance can be calculated before the process starts.

Deductive Object-Oriented Data Mining System (Doodms) invented by the applicant of this patent satisfies all requirements mentioned above. Based on probability theory, and without losing generality, Doodms generates prediction rules as probabilities of something that will happen under different conditions. Applying no heuristics, Doodms is mathematically rigorous and accurate. Since new theorems are proved and applied, Doodms is fast enough to solve many data mining problems that couldn't be solved by other similar systems.

### SUMMARY OF THE INVENTION

Deductive Object-Oriented Data Mining System (Doodms) is a predictive data mining system. Its goal is generating prediction rules from given databases or any given data sets. In Doodms, a difficult data mining problem is reduced to a series of probability problems, each of which is not only much easier to be solved but also has much better mathematical basis. Generate-count-and-test methodology, which contains generate, count, and test processes, is applied in Doodms.

In generate-process, Doodms generates less general objects from more general objects by conjunctive generation. The generated object can be called the conjunctive object (CO). In Doodms, each given instance is transferred to an object, called the working object (WO), and all given instances are transferred to the working object space (WOS).

Two threshold conditions, the minimum sample size threshold condition and the minimum probability threshold condition, are introduced. Each generated CO must be tested by these two conditions. Any generated CO that passes the test of the minimum sample size threshold condition will be a qualified CO (QCO) and copied to the generation-list used to generate the next level COs, the less general COs. And any generated CO that fails to pass the test of the minimum sample size threshold condition will be an unqualified CO (UCO), and will be dropped. Moreover, it has been proved as a theorem by the applicant that, any CO that could be generated by an UCO would not pass the test of the minimum sample size threshold condition and could be dropped. This will save a lot of data mining time. Any generated CO that passes tests of both threshold conditions will be a resultant CO (RCO) and will be copied to the resultant-list. All RCOs in the resultant-list will be transferred to generated prediction rules. The above principles are the basic principles applied in Doodms.

### DESCRIPTION OF THE INVENTION

Deductive Object-Oriented Data Mining System (Doodms) is a system that applies object-oriented and deductive methodologies to solve data mining problems. Since the technology applied in Doodms belongs to the area of machine learning, the engine in Doodms is called the Deductive Object-Oriented Learning Engine (Doole). And the data mining process performed in Doole is a machine learning process, or called a learning process.

1. An Example: Let's Start our Discussion From an Example.

Currently, the hospital uses the database for each patient as an independent individual. When a patient visits the hospital, doctors and nurses check his/her medical data as references for today's diagnosis and treatment, and accountant department checks his/her financial data. In each case, the hospital only needs a single patient's data. However, if we can consider the data of all patients as a whole, we can generate much more knowledge from the database than treating each patient as an independent individual.

Supposing there is a heart disease database of 5,000 patients. By counting the database, we find that 1,000 patients in the database have (systolic) blood pressure higher than 200. Among these 1,000 patients, 700 patients suffer from heart attack, and 300 patients don't. Accordingly, we can generate a prediction rule by direct count that if a patient's blood pressure is higher than 200, there is 700/1,000=70% probability of heart attack. We can generate prediction rules by the same method for blood pressure groups of 180-200, 160-180, 140-160, 120-140, and <120. If there are six blood pressure groups, it is not difficult to generate six prediction rules by direct count manually for these six groups.

More precisely, we find by counting that among the 700 heart attack patients, 400 are males and 300 are females, and among the 300 non-heart attack patients, 140 are males and 160 are females. Therefore, the probability of heart attack for males with blood pressure higher than 200 is 400/(400+140)=74%, and for females is 300/(300+160)=65%. These two prediction rules having two attributes, blood pressure and gender, are generated by direct count from the database. If there are six blood pressure groups and two different genders, the combination of values in these two attributes are 6*2=12 cases. It is still no problem to generate twelve prediction rules for these twelve cases by direct count manually.

Similarly, we can generate prediction rules of heart attack for different age groups, different cholesterol levels, different weight groups, . . . etc. If there are 6 blood pressure groups, 2 genders, 7 age groups, 5 cholesterol levels, and 5 weight levels for five attributes, then there are 6*2*7*5*5=2,100 combination elements in the attribute-value space. To generate prediction rules, all these 2,100 cases have to be counted. To count numbers of elements in all of the 2,100 cases manually is difficult, but we believe that computers can do it. This is the basic principle of data mining.

Because of the very high speed and big memory of modern computers, we think we can generate prediction rules based on the principle mentioned above from any database. Actually, it is not true.

If there are twenty attributes similar with the five attributes in the example mentioned above, there will be 2,100⁴=2*10¹³ (twenty trillion) combinations. If there are forty similar attributes, there will be 4*10²⁶ combinations. It will take thousands of years to complete the count of so many combination cases, even by the best modern computer.

In order to speed up the data mining process, different heuristics are introduced by different authors. Heuristics are some assumptions, which look like reasonable or have been proved as acceptable approximations in some special cases. However, such heuristics are correct or acceptable only in some special cases but not in other cases and the general case.

Because some special technologies as mentioned in the following sections are applied, Doodms greatly speeds up the data mining process without the using of any heuristics. Following are the detailed description of Doodms.

2. Data Selection and Data Preparation

In Doodms, a difficult data mining problem is reduced to a series of probability problems, which are much more easier to be solved and have much better mathematical basis. The methodology applied in Doodms is generate-count-and-test methodology, which contains generate, count, and test processes.

A database contains many attributes and instances, and can be reduced to a spreadsheet, each column of which corresponds to an attribute and each row of which corresponds to an instance.

All or a part of all attributes in the given database can be selected as selected attributes. In order to do object-oriented data mining, a learning class (LC) composed of all selected attributes is created. One or more attributes in the learning class are selected as decision-attributes, and the others as data-attributes. Because the machine learning technology is applied in Doodms, the created class is called the learning class (LC). Moreover, three additional attributes, the positive count attribute, the negative count attribute, and the probability attribute, are added or linked to the learning class. All or a part of all given instances in the given database are selected as selected instances. And each selected instance has a corresponding learning object (LO) in the LC.

Any LO that has a corresponding selected instance is called a working object (WO), and all working objects form a working object space (WOS). In Doodms, data mining is processed in the working object space rather than the attribute-value space (AVS), which is composed of combinations of all values in all attributes. Deductive technology is doing data mining from more general cases to less general cases. The system generates less general objects from more general objects.

In each decision-attribute, one or more values are selected as positive decision values (PDVs), and other values are defined as negative decision values. An instance is defined as a positive instance, if all of its decision-attributes take PDVs; otherwise it is defined as a negative instance. A working object corresponding to a positive instance is defined as a positive working object (PWO); a working object corresponding to a negative instance is defined as a negative working object (NWO);

A value in a data-attribute is called a data-value. In an attribute, values taken by all WOs are possible values of this attribute. Moreover, “don't care”, a value defined as matching all possible values in its corresponding field, is a possible data-value for all data-attributes. All possible values of an attribute form a possible value-list of this attribute. And the combination elements of all values in all data-attributes form the attribute-value space (AVS).

A learning object (LO) is an object in the learning class, and each field of this object can take a possible value, and at least one of which is non-blank.

Fuzzification for continuous or consecutive values is necessary in the learning process. In a medical problem, we cannot find any obvious difference between patients of ages 31 and 32, or of 45 and 46. However, if we fuzzify the age into age groups, such as 20-30, 30-40, 40-50, 50-60, etc., we can definitely find some differences between different age groups. In case, an attribute having too many different values, fuzzification enables Doodms generating good results.

3. Some Terminologies

In order to implement the generate-count-and-test process, the following terminologies are used.

Match and value “don't care”. Fields in the same attribute of two different LOs are called corresponding fields. If values in corresponding fields of two different LOs are equal, these two fields are defined as matching each other. Moreover, by definition, value “don't care” can match any value in its corresponding field. Therefore, if the value in any data-field is “don't care”, the field will match all corresponding fields Two LOs are defined as match each other, if all corresponding fields of these two LOs match each other. Since a “don't care” value in a field is expressed as a blank field in this patent description, a non-blank field means that the value in this field is not a “don't care”.

Ranks A LO in the learning class having m data-attributes has m data-fields. If only k data-fields have non-blank values (1‘<=k<=m), and blanks (“don't care”) in all others, the LO is said as a LO with conjunctive rank k (or simply say rank k). A LO with less k is said with higher rank and is more general. It is obvious that the highest rank object is the object of rank 1, which has only a single non-blank field.

Conjunctive object (CO) and conjunctive generation. The generate-process in Doodms is a conjunctive generation process. It can be explained as follows: LO₁ and LO₂ are LOs in the same learning class. LO₁ has non-blank fields n₁₁, n₁₂, n₁₃, . . . n₁ₜ, with values V₁₁, V₁₂, V₁₃, . . . V₁ₜ, respectively; LO₂ has non-blank fields n₂₁, n₂₂, n₂₃, . . . n₂ₛ, with values U₂₁, U₂₂, U₂₃, . . . U₂ₛ, respectively. While n₁₁, n₁₂, n₁₃, . . . n₁ₜ, and n₂₁, n₂₂, n₂₃, . . . n₂ₛ, are mutually exclusive. The conjunctive object LO₃ generated by the conjunctive generation of LO₁ and LO₂ is a LO that has non-blank fields n₁₁, n₁₂, n₁₃, . . . n₁ₜ, and n₂₁, n₂₂, n₂₃, . . . n₂ₛ, with values V₁₁, V₁₂, V₁₃, . . . V₁ₜ, and U₂₁, U₂₂, U₂₃, . . . U₂ₛ, respectively. Therefore, a Conjunctive Object (CO) is a LO generated by the conjunctive generation from two or more LOs of higher rank.

Definition of a WO matching a CO: A WO is defined as matching a CO, if and only if all non-blank data-fields in the CO have the same value as that in the corresponding fields of the WO.

Positive count and negative count of a CO: A CO is not necessarily a working object (WO) in the WOS, but it can match some WOs. The number of the positive working objects (PWOs) matching a CO is the positive count value (or simply, positive count) p of this CO, and can be stored in the positive count field of this CO. The number of the negative working objects (NWOs) matching a CO is the negative count value (or simply, negative count) g of this CO, and can be stored in the negative count field of this CO.

The probability of a CO: The probability value (or simply, probability) B of a CO is the probability of a CO to be a positive object. It can be defined by the following formula:

B=p/(p+g). (1.1)

Where p is the positive count value and g is the negative count value of the CO.

The probability value B calculated from the above formula will be entered to the probability field, which is the third additional field in the learning object.

Threshold conditions. Two threshold conditions are applied in Doodms:

Threshold Condition #1: The Minimum Sample Size Threshold Condition (TC-1). The end user can set a minimum sample size threshold value Pₘᵢₙ for the positive count, where Pₘᵢₙ is a positive integer. A learning object is defined as satisfying TC-1, if the positive count value p satisfies:

p>=Pₘᵢₙ. (1.2)

The sample size in TC-1 is very important from the statistical viewpoint. To flip up a coin, the possibility of each side up is 50%. If we flip up a coin 1,000 times, each side up will be very close to five hundred times. But if we flip it up only twice, there is no guarantee that each side up will be once. Therefore, if we want to make a probability rule statistically correct, a minimum sample size is required. The bigger the sample size we take, the more accurate the probability rules we have.

The total count (p+g), the positive count p, or a function of p and/or g can be taken as the measurement of the sample size. Here we take the positive count p as the sample size measurement, because it can speed up the learning process.

Threshold Condition #2: The Minimum Probability Threshold Condition (TC-2). The end user can set a threshold value Bₘᵢₙ for the probability B, with 0<=Bₘᵢₙ<=1. A learning object is defined as satisfying TC-2, if its probability B satisfies:

B>=Bₘᵢₙ. (1.3)

The two threshold values, Pₘᵢₙ and Bₘᵢₙ, are given by the user before the data mining process starts.

4. Generation of Seeds

In Doodms, the generate-process is performed in AVS, and the count-and-test process is performed in WOS.

Seed objects (or called Seeds) are a set of LOs, which serve as the start points of the generate-process. In the deductive learning process, seeds are selected from the most general LOs, each one of which has a single non-blank field only. This means that each seed has value “don't care” in all data-fields except a single non-blank one.

Generation of seeds: The generate-process starts at the seed generation. A potential seed (PS) is a LO of rank 1, i.e., a LO with a single non-blank field. Doodms will test all potential seeds (PSs) by TC-1. All PSs that fail to pass the test of TC-1 will be dropped, and all PSs that pass the test of TC-1 will be seeds and stored in a seed-list. All seeds in the seed-list will be taken to generate COs of lower rank. And all seeds in the seed-list will be tested by TC-2. Any seed passes the test of TC-2 can be transferred to a generated prediction rule and will be copied to the resultant-list.

Since seeds can be used to generate new COs, a seed can be viewed as a CO of rank 1, and is a CO of highest rank. Any LO will match a seed, if and only if it has the same value as that in the corresponding non-blank field of the seed, no matter what values are in other fields.

5. Count-and-Test Process

The count process is performed in WOS. Doodms can count the number of all PWOs matching the generated CO and write the number as the positive count p of the generated CO; and Doodms can count the number of all NWOs matching the generated CO and write the number as the negative count g of the generated CO. With p and g, the probability B of this CO can be calculated, and the CO can be tested by TC-1 and TC-2.

Unqualified object and unqualified CO: Any object passes the test of TC-1 is called a qualified object; and any object fails to pass the test of TC-1 is called an unqualified object. Any CO passes the test of TC-1 is called a qualified CO (QCO); and any CO fails to pass the test of TC-1 is called an unqualified CO (UCO).

After a CO of rank k is generated and its positive count p and negative count g are obtained by counting, it will be tested by TC-1. All QCOs of rank k will be put in a generation-list of rank k. All COs of rank k in the generation-list can be taken to generate COs of lower rank (with larger k). All UCOs will be dropped.

Doodms will calculate the probability B of all COs in the generation-list by formula (1.1), and test each CO in the generation-list by TC-2. Any CO in the generation-list that passes the test of TC-2, will be a generated prediction rule and copied to the resultant-list.

After all COs of rank k are generated, counted, and tested, Doodms will start to generate CO of rank k+1.

6. Unqualified-Generated COs

A CO is defined as an unqualified-generated CO (UGCO), if it could be generated by the conjunction of an UCO with any other CO or COs. This means that even a CO is actually generated by the conjunction of all QCOs, it is an UGCO if it could be generated by the conjunction of an UCO with others. And the applicant of this patent has proved a theorem that an UGCO is an UCO, i.e., it cannot pass the test of TC-1. The theorem can be stated as:

Any CO will be an UCO, if it could be generated by the conjunctive generation of an UCO with any other CO or COs.

This means that a CO is an UCO, if it has the possibility to be generated by the conjunction of any UCO with some others, even it is not directly generated by them. This kind of COs can be dropped before the count-and-test process starts.

Let's explain it by an example. Suppose we have COs: CO-1=“abxxxx”, CO-2=“xbcxxx”, CO-3=“xxcdxx”, CO-4=“axxdxx” . . . etc. In the above expression, “x” expresses a blank field (don't care). Therefore, CO-1 has value a in attribute #1, value b in attribute #2, and blanks in all other fields. CO-2 has value b in attribute #2, value c in attribute #3, and blanks in all other fields. CO-3 has value c in attribute #3, value d in attribute #4, and blanks in all other fields. CO-4 has value a in attribute #1, value d in attribute #4, and blanks in all other fields.

Suppose that CO-1, CO-3, and CO-4 pass the test of TC-1 and are QCOs, and CO-2 doesn't pass the test of TC-1 and is an UCO. A new CO called CO-5=“abcdxx” can be generated by the conjunction of two QCOs: CO-1 and CO-3. But it is easy to find that the CO-5, “abcdxx”, could be generated by the conjunction of CO-2, “xbcxxx”, and CO-4, “axxdxx”, too. Although CO-5 is not generated directly by any UCO, but it could be generated by the conjunction of an unqualified CO-2 with some others. Therefore it is an UGCO. By the above-mentioned theorem, CO-5 is an UCO, and can be dropped before the count-and-test process starts. And a lot of time can be saved.

7. The Prediction Rule and the Learning Object

A CO passing tests of TC-1 and TC-2 will be copied to the resultant-list by Doodms, and can be transferred to a prediction rule as follows:

Supposing the CO has n data-attributes and hence n data-fields, in which m (m<=n) data-fields are non-blank. Let these m data-fields be in data-attributes Aᵢ₁, Aᵢ₂, . . . Aᵢₘ with values Vᵢ₁, Vᵢ₂, . . . Vᵢₘ respectively. Its decision-attribute is Ad and the positive decision value is Vₚ, and the probability calculated is B. The prediction rule can be expressed as:

If Aᵢ₁=Vᵢ₁, and

Aᵢ₂=Vᵢ₂, and

. . .

Aᵢₘ=Vᵢₘ

Then the probability of A_{d}=Vₚ is B.

8. Learning Relations

In case no LC can be created, such as in some non-object-oriented programming language, Basic, C, Pascal, Fortran, etc., Doodms can create an array, a structure, a table, or any other data structures, that can take attributes and instances, to replace a LC. This kind of data structures is called a learning relation (LR), which has a set of data-attributes, a set of decision-attributes, and a set of tuples (rows). All deductive object-oriented technologies mentioned in this application still can be applied as follows.

All or a part of all attributes in the given database can be selected as selected attributes. A learning relation (LR) composed of all selected attributes is created. One or more attributes in the LR are selected as decision-attributes, and the others as data-attributes. Using the object-oriented terminology in this case, each tuple (row) of the LR is called a learning object (LO) of this LR. Moreover, three additional attributes, the positive count attribute, the negative count attribute, and the probability attribute, are added or linked to the LR. All or a part of all given instances in the given database are selected as selected instances. And each selected instance has a corresponding learning object (LO) in the LR. Any LO that has a corresponding selected instance in the LR is called a working object (WO), and all working objects form a working object space (WOS).

In each decision-attribute, one or more values are selected as positive decision values (PDVs), and other values are defined as negative decision values. An instance is defined as a positive instance, if all of its decision-attributes take PDVs; otherwise it is defined as a negative instance. A WO corresponding to a positive instance is defined as a positive working object (PWO); a working object corresponding to a negative instance is defined as a negative working object (NWO).

A value in a data-attribute is called a data-value. In an attribute, values taken by all WOs are possible values of this attribute. Moreover, “don't care”, a value defined as matching all possible values in its corresponding field, is a possible data-value for all data-attributes. All possible values for an attribute form a possible value-list of this attribute. And the combination elements of all values in all data-attributes form the attribute-value space (AVS).

Therefore, all definitions, such as, conjunctive generation, seed, CO QCO, UCO, UGCO, RCO, TC-1, TC-2, etc., and all deductive object-oriented processes and technologies mentioned in Sections 2-7 still can be applied.

The generation of seeds and COs are performed in AVS, and each generated CO must be compared with each WO to find out all matched WOs. Therefore, the count-and-test process is performed in WOS. Every generated CO and every compared WO are viewed as an object, conjunctive object or working object, with the same set of decision-attributes and set of data-attributes, no matter they are in a LC or a LR. This is the reason the technology is called object-oriented, no matter all objects are in a set of LCs or LRs.

### DETAILED DESCRIPTION OF DRAWINGS

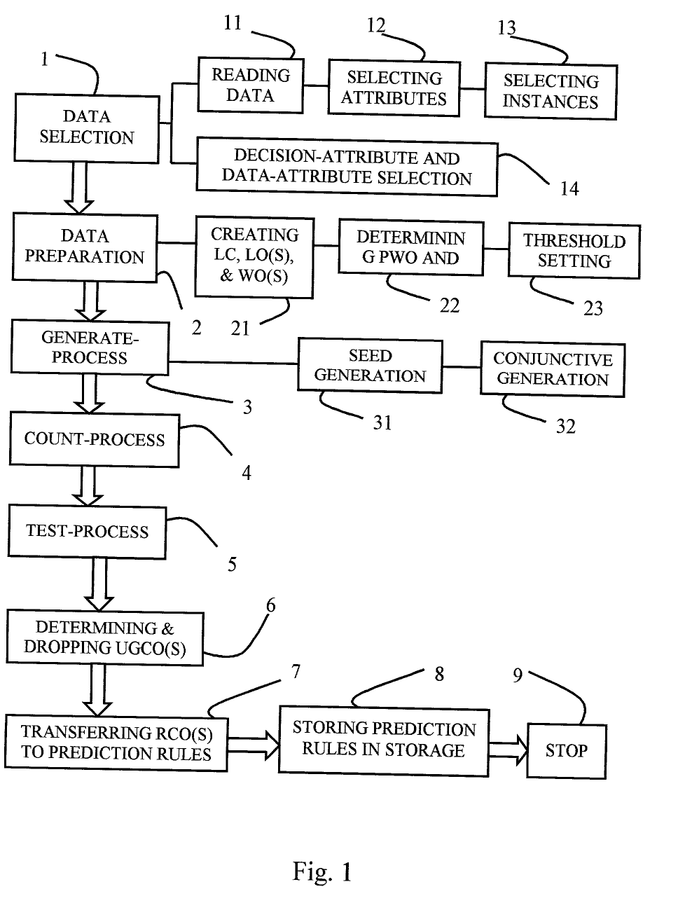

In Doodms, data mining tasks are performed by its data mining engine. Since machine learning technology is the theoretical basis of the data mining engine, the engine is called the deductive object-oriented learning engine (Doole). The structure of Doole is shown in FIG. 1, and is explained as follows:

Block 1. Data selection: To do data mining, we need source data. The source data can be a database, a set of databases, a set of data in pixels, a set of data from sensors, and so on. The first step is to read the source data, select relevant and interested data from the source data, and enter the selected data to the data mining system. It includes:

Block 11. Reading data: To read source data from the storage of the source data.

Block 12. Selecting attributes: Selecting a set of selected attributes from attributes of the source data.

Block 13. Selecting instances: Selecting a set of selected instances from instances of the source data.

Block 14. Decision-attributes selection: Selecting a set of decision-attributes from selected attributes, and others will be data-attributes.

Block 2. Data preparation: Data preparation includes the following tasks:

Block 21. Creating LC, LOs, and WOs: In order to do object-oriented data mining design and programming, a learning class (LC) comprised of all selected attributes is created. And decision-attributes and data-attributes are selected from all selected attributes. Any object in LC is a learning object (LO). And any LO having a corresponding selected instance is called a working object (WO), because any generated CO will be compared with all WOs in the count-process. And all WOs form a space called the working object space (WOS).

A value in a field in a data-attribute is called a data-value. In an attribute, a value taken by any WO is a possible value of this attribute. Moreover, value “don't care”, written as a blank field, is a possible value for all attributes. All possible values of an attribute form a value-list of this attribute. Combination elements of all possible values in all data-attributes form an attribute-value space (AVS).

A LO is an object in the learning class. A field of a LO can take any value of the value-list of its corresponding attribute. A WO is a LO, because WO is an object in this LC and any object in this LC is a LO of this LC. However, a LO is not necessarily a WO, because it does not necessarily have a corresponding selected instance. In general case, the number of WOs is much less than the number of all LOs. Therefore, WOS, in general, is much less than AVS.

Block 22. Determining PWO and NOW: In data-preparation process, positive decision value or values and negative decision value or values in each decision-attribute must be determined by the user, and PWOs and NWOs will be determined by Doole. Two WOs having the same data-value in all data-attributes are called identical WOs. All identical WOs can be combined as a single WO, and the positive count p and the negative count g are marked with the combined WO to express how many PWOs and NWOs are combined in it.

Besides the selected attributes, three additional attributes, the positive count attribute, the negative count attribute, and the probability attribute can be added to the LC. And hence, three more additional fields, the positive count field, the negative count field, and the probability field are added to each LO.

Block 23. Threshold setting: The user assigns two threshold values, the minimum sample size threshold value and the minimum probability threshold value. In order to apply TC-1 and TC-2, values of these two thresholds must be assigned by the user before the data mining process starts.

Block 3. Generate-process: The generate-process is the first process of the generate-count-and-test process. It includes seed generation and conjunctive generation.

Block 31. Seed generation: Seeds are a set of learning objects, which serve as the start point of the generate-process. In the deductive learning process, seeds are selected from the most general LOs, each of which has only a single non-blank field, i.e., each seed has “don't care” values (blank fields) in all data-fields except a single non-blank one. The value of the non-blank field can be any one taken from its corresponding value-list. A seed can be viewed as a CO of rank one.

Block 32. Conjunctive generation: Conjunctive generation is a process to generate a new CO by the conjunction of two or more COs. Once all COs of rank k are generated, counted, and tested, next level COs of rank (k+1) will be generated by conjunctive generation. The simplest method is to generate a CO of rank (k+1) by the conjunction of a QCO of rank k and a seed, which is of rank 1.

Block 4. Count-process: In this process, how many PWOs and NWOs can match the generated CO are counted. Once a CO is generated by conjunctive generation, it must be compared with all WOs in WOS, and numbers of matched PWOs and NWOs must be counted. The number of matched PWOs is the positive count value p of this CO and will be stored in the positive count field corresponding to this CO; the number of matched NWOs is the negative count value g of this CO and will be stored in the negative count field corresponding to this CO.

The probability value B of a generated CO is defined as the probability of the CO to be a positive learning object. It can be calculated from its positive count p and negative count g by formula (1.1).

Block 5. Test-Process: In this process, all generated COs will be tested by TC-1. A CO that fails to pass the test of TC-1 is an UCO, and will be dropped; a CO that passes the test of TC-1 is a QCO and will be stored in a generation-list for the generation of next level COs. All QCOs will be tested by TC-2. A QCO that passes the test of TC-2 will be a resultant CO (RCO) and copied to the resultant-list.

Block 6. Determining and dropping unqualified-generated COs (UGCOs): This is one of the most important processes in Doole, because it can greatly speed up the data mining process and solve the most difficult data mining problem, the time complexity problem. This process is introduced and developed in this invention, and is applied to data mining area for the first time.

A generated CO needs to be compared with all WOs in WOS in the count-and-test process. It is a time-consuming process. If more COs can be dropped before the count-and-test process starts, a lot of time can be saved. The applicant of this patent has proved a very important theorem, which is as follows:

Any CO will be an UCO, if it could be generated by the conjunctive generation of an UCO with any other CO or COs.

A CO is called an unqualified-generated CO (UGCO), if it has the possibility to be generated from any UCO. Once a CO is determined being an UGCO, it will be dropped at once, no count-and-test process is needed for this CO. Therefore, to determine UGCOs is one of the most important tasks in Doole.

Block 7. Transferring RCOs to prediction rules in required formats: Before stop, Doole will transfer all RCOs in the generation-list to prediction rules in required formats. The most general required formats comprise rule format and table format.

Block 8. Storing prediction rules in computer storage: The result needs to be stored in computer storage.

Block 9. Stop: If no RCO is generated in rank k or under the user's instruction, the Doodms will stop.

### Acronym

AVS: Attribute-Value Space

CO: Conjunctive Object

Doodms: Deductive Object-Oriented Data Mining System

Doole: Deductive Object-Oriented Learning Engine

LC: Learning Class

LO: Learning Object

NWO: Negative Working Object

PDV: Positive Decision Value

PS: Potential Seed

PWO: Positive Working Object

QCO: Qualified Conjunctive Object

RCO: Resultant Conjunctive Object

TC-1: Threshold Condition #1 (Minimum Sample Size Threshold Condition)

TC-2: Threshold Condition #2 (Minimum Probability Threshold Condition)

UCO: Unqualified Conjunctive Object

UGCO: Unqualified-Generated Conjunctive Object

WO: Working Object

WOS: Working Object Space

I claim:

1. A deductive object-oriented data mining system in a set of digital computers performing data mining through the aid of a set of CPUs of said set of digital computers, comprising:
a set of input/output means for reading data and generating output;
a set of computer storing means for storing data and computer programs;
a set of deductive object-oriented learning engines being a set of executable computer programs stored in said set of computer storing means for mining source data and generating a set of prediction rules through the aid of said set of CPUs of said set of digital computers;
wherein
said set of deductive object-oriented learning engines comprising:
a. means for reading data from said source data through said set of input/output means;
b. means for selecting a set of decision-attributes and a set of data-attributes from attributes of said source data, and means for selecting a set of selected instances from instances of said source data;
c. means for creating a set of learning classes in said set of computer storing means, each of said set of learning classes comprising said set of data-attributes and said set of decision-attributes;
d. means for transferring said set of selected instances to a set of working objects in said set of learning classes;
e. means for assigning a set of positive decision values and a set of negative decision values in values of said set of decision-attributes, and for classifying said set of working objects into positive working objects and negative working objects;
f. means for assigning a set of threshold conditions and accepting a set of threshold values;
g. means for generating a set of seeds;
h. means for conjunctive generation of a set of conjunctive objects;
i. means for counting positive count and negative count, and calculating probability of each of said set of conjunctive objects;
j. means for testing each of said set of conjunctive objects by said set of threshold conditions, and means for determining a set of unqualified conjunctive objects, a set of qualified conjunctive objects, and a set of resultant conjunctive objects;
k. means for determining a set of unqualified-generated conjunctive objects;
l. means for transferring said set of qualified conjunctive objects in said set of resultant-lists to a set of prediction rules; and
m. means for generating said set of prediction rules in said set of computer storing means.

2. The set of deductive object-oriented learning engines of claim 1 further comprises means for combining all identical working objects in said set of working objects as a single working object.

3. Each of said set of deductive object-oriented learning engines of claim 1 further comprises means for creating a set of additional attributes comprising positive count attribute, negative count attribute, and probability attribute for each of said set of learning classes.

4. Each of said set of deductive object-oriented learning engines of claim 1 wherein said means for assigning a set of threshold conditions and accepting a set of threshold values comprises means for assigning minimum sample size threshold condition and accepting minimum sample size threshold value, and means for assigning minimum probability threshold condition and accepting minimum probability threshold value.

5. Each of said set of deductive object-oriented learning engines of claim 1 further comprises means for fuzzifying values in said set of data-attributes and said set of decision-attributes.

6. The deductive object-oriented data mining system of claim 1 wherein said set of learning classes is a set of learning relations.
